(19) United States
(12) Patent Application Publication
(10) Pub. No.: US 2002/0036966 A1
(43) Pub. Date: Mar. 28, 2002

(54) TRACKING CONTROL METHOD AND TRACKING CONTROL APPARATUS IN WHICH A TRACKING OFFSET COMPONENT IS SUBTRACTED FROM A TRACKING ERROR

(76) Inventors: SHOGO MIYANABE, TSURUGASHIMA-SHI (JP); HIROKI KURIBAYASHI, TSURUGASHIMA-SHI (JP)

Correspondence Address: SUGHRUE MION ZINN, MACPEAK & SEAS, 2100 PENNSYLVANIA AVENUE NW, WASHINGTON, DC, 200373202

(21) Appl. No.: 09/209,425

(22) Filed: Dec. 11, 1998

(30) Foreign Application Priority Data
Dec. 15, 1997 (JP) 9-345308

(51) Int. Cl. G11B 7/00

(52) U.S. Cl. 369/53.28; 369/53.33

(57) ABSTRACT

A tracking control method and a tracking control apparatus in a recorded information reproducing apparatus which can execure an accurate tracking control even if recording tracks formed on a recording disk have a narrow track pitch. A tracking offset component is detected based on a balance between crosstalk amounts from the recording tracks adjacent to both sides of the recording track serving as a reading target and is subtracted from a tracking error signal, thereby performing a tracking offset correction.

### BACKGROUND OF THE INVENTION

1. Field of the Invention

The present invention relates to a tracking control in a recorded information reproducing apparatus for reading recorded information from recording tracks formed on a recording medium.

2. Description of Related Art

In order to accurately read recorded information from an optical disk as a recording medium, it is indispensable to use a tracking control technique for controlling an information reading beam so as to trace a recording track formed on the optical disk.

In the tracking control scheme, two photodetectors for receiving reflection light when the information reading beam is irradiated onto the recording disk are symmetrically arranged with respect to the center of the recording track, respectively. A difference between photoelectrically converted outputs from the two photodetectors is obtained as a tracking error signal and an irradiating position of the information reading beam is adjusted so that a signal level of the tracking error signal is converged to “0”.

When a distance between the recording tracks, namely, what is called a track pitch is narrowed in order to realize high density recording, the read signal however is influenced by a crosstalk from the neighboring track and an offset component is multiplexed into the tracking error signal.

When the offset component is multiplexed into the tracking error signal, a level difference between the tracking error signal which is obtained when the information reading beam is in an on-track state and the tracking error signal which is obtained when the information reading beam is in an off-track state becomes small and a problem arises such that the tracking control may not be performed accurately.

### OBJECT AND SUMMARY OF THE INVENTION

The invention is made to solve the problem and it is an object to provide a tracking control method and a tracking control apparatus in a recorded information reproducing apparatus, in which an accurate tracking control can be executed even if recording tracks formed on a recording disk has a small track pitch.

According to the invention, there is provided a tracking control method in a recorded information reproducing apparatus having tracking error detecting means for detecting a tracking error based on a read signal obtained by photoelectrically converting reflection light when an information reading beam is irradiated onto a recording disk and a tracking actuator for allowing the information reading beam to trace a recording track on the recording disk based on the tracking error, wherein a tracking offset is corrected by subtracting a value according to a balance between crosstalk amounts from recording tracks which are neighboring on both sides of the recording track as a reading target from the tracking error.

According to the invention, there is provided a tracking control apparatus in a recorded information reproducing apparatus having tracking error detecting means for detecting a tracking error based on a read signal obtained by photoelectrically converting reflection light when an information reading beam is irradiated onto a recording disk and a tracking actuator for allowing the information reading beam to trace a recording track on the recording disk based on the tracking error, comprising: crosstalk detecting means for detecting crosstalk amounts from recording tracks which are neighboring on both sides of the recording track as a first crosstalk and a second crosstalk based on the read signal; a first subtractor for obtaining a value according to a balance between the first crosstalk and the second crosstalk as a tracking offset component; and a second subtractor for subtracting the tracking offset component from the tracking error.

### BRIEF DESCRIPTION OF THE DRAWINGS

FIG. 1 is a diagram showing the construction of a recorded information reproducing apparatus having a tracking control apparatus for executing a tracking control in accordance with a tracking control method of the invention;

FIG. 2 is a diagram showing a positional relation among beam spots PA to PC and recording tracks on a recording disk 3; and

FIG. 3 is a diagram showing an internal construction of a tracking offset detecting circuit 20.

### DETAILED DESCRIPTION OF THE PREFERRED EMBODIMENT

An embodiment of the invention will be described hereinafter.

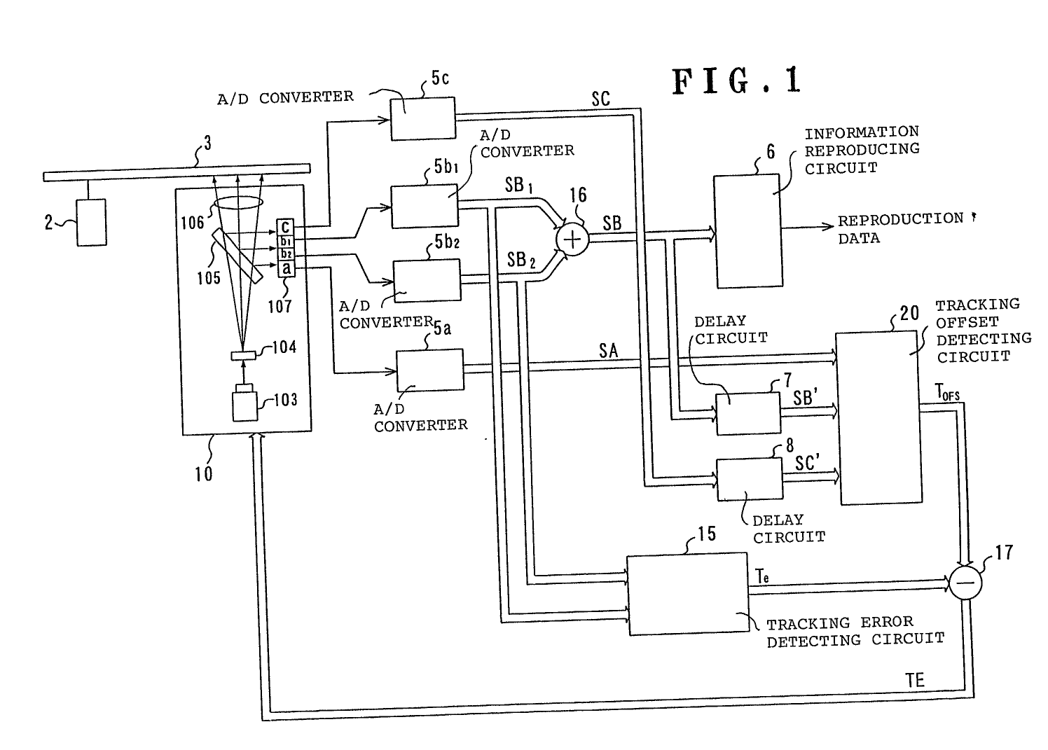

FIG. 1 is a diagram showing the construction of a recorded information reproducing apparatus having a tracking control apparatus for executing a tracking control based on a tracking control method according to the invention.

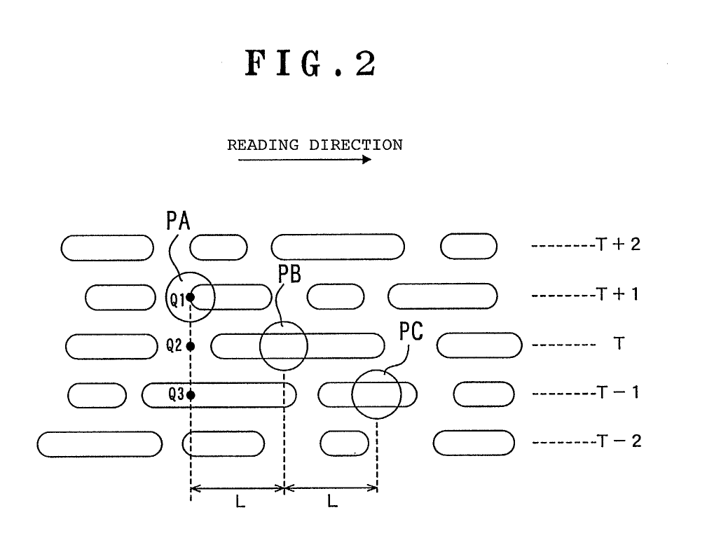

In FIG. 1, a laser beam emitted from a laser oscillator 103 mounted on a pickup 10 serving as information reading means is divided into three information reading beams via a grating 104. The three information reading beams are irradiated onto a recording surface of a recording disk 3 via a half mirror 105 and an objective lens 106. The three information reading beams are irradiated to three recording tracks which are neighboring on the recording surface of the recording disk 3, respectively. By the three information reading beams, for example, as shown in FIG. 2, beam spots PA to PC are formed on recording tracks (T+1), T, and (T−1), respectively, which are neighboring on the recording disk 3. In this case, as shown in FIG. 2, it is assumed that the beam spots PA and PB are away from each other by a distance (L) in the reading direction and the beam spots PA and PB are also away from each other by the distance (L).

Reflection lights by the beam spots PA, PB, and PC are irradiated to a photodetector 107 via the objective lens 106 and half mirror 105. The photodetector 107 comprises independent photodetectors 107a to 107c.

The photodetector 107a supplies a read signal obtained by photoelectrically converting the reflection light from the beam spot PA supplied via the half mirror 105 to an A/D converter 5a. The photodetectors 107b₁, and 107b₂ are arranged so as to be symmetrical with respect to the center of the recording track and supply read signals obtained by photoelectrically converting the reflection light from the beam spot PB to A/D converters 5b₁ and 5b₂. The photodetector 107c supplies a read signal obtained by photoelectrically converting the reflection light from the beam spot PC to an A/D converter 5c.

It is assumed that the parallel relation between the recording surface of the recording disk 3 and the pickup 10 is maintained and the three information reading beams from the pickup 10 are irradiated perpendicularly to the recording surface.

The A/D converters 5a, 5b₁, 5b₂, and 5c sequentially sample the read signals derived by the reading means (a) to (c), thereby obtaining read sampling value sequences SA, SB₁, SB₂, and SC, respectively. An adder 16 adds the read sampling value sequences SB₁ and SB₂, thereby obtaining a read sampling value sequence SB and supplies it to an information reproducing circuit 6. The information reproducing circuit 6 reproduces information data recorded on the recording disk 3 based on the read sampling value sequence SB and generates reproduction data obtained in this instance.

A tracking error detecting circuit 15 obtains, for example, a difference between the read sampling value sequences SB₁ and SB₂ and supplies the difference as a tracking error signal Tₑ to a subtractor 17. A method of generating the tracking error signal is not limited to the above method. For example, another tracking error detecting method such as a phase difference detecting method or the like can be used.

A delay circuit 7 supplies a delayed read sampling value sequence SB′ obtained by delaying the read sampling value sequence SB by the time of (L/V) to a tracking offset detecting circuit 20. A delay circuit 8 supplies a delayed read sampling value sequence SC′ obtained by delaying the read sampling value sequence SC by the time of 2·(L/V) to the tracking offset detecting circuit 20. In this instance, the read sampling value sequence SA generated from the A/D converter 5a is directly supplied to the tracking offset detecting circuit 20. “L” denotes the distance between the beam spots PB and PC (PA) as shown in FIG. 2 and “V” indicates a reading linear velocity of the pickup 10 for the recording disk 3.

In the case where the read sampling value sequence SA indicates a value derived when the reading operation is performed at a position Q₁ on the recording track (T+1) as shown in FIG. 2, therefore, the delayed read sampling value sequence SB′ indicates a value obtained when the reading operation is executed at a position Q₂ on the recording track T. The delayed read sampling value sequence SC′ indicates a value obtained when the reading operation is performed at a position Q₃ on the recording track (T−1). The positions Q₁ to Q₃ exist on the same radial line on the recording disk 3. That is, the read sampling value sequences (SA, SB′, SC′) of three systems read out from the positions existing on the same radial line on the three adjacent recording tracks are supplied to the tracking offset detecting circuit 20.

The tracking offset detecting circuit 20 detects a tracking offset component multiplexed in the tracking error signal Tₑ based on the read sampling value sequence SA and the delayed read sampling value sequences SB′ and SC′ and supplies a tracking offset signal T_{OFS} corresponding to the tracking offset component to the subtractor 17.

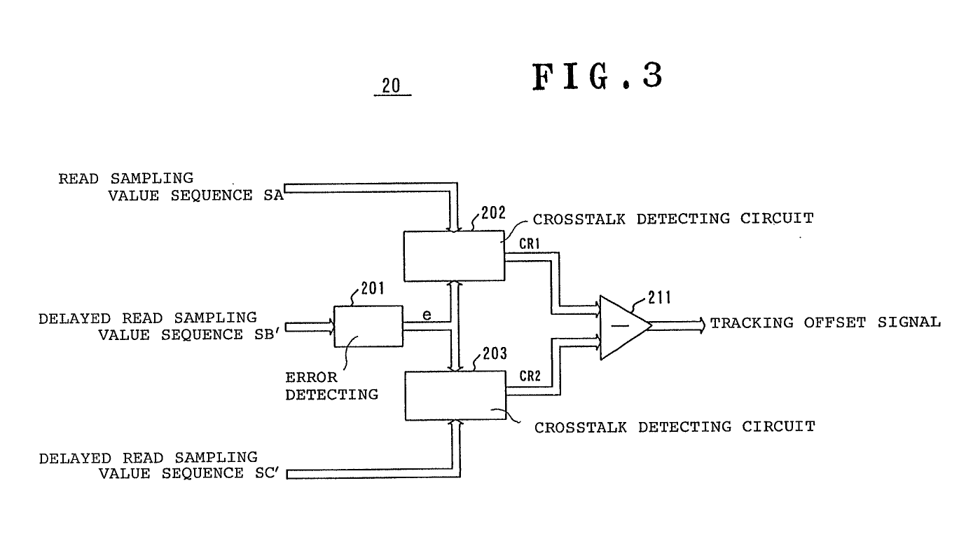

FIG. 3 is a diagram showing an internal construction of the tracking offset detecting circuit 20.

In FIG. 3, an error detecting circuit 201 detects an error between each of the read sampling values in the delayed read sampling value sequence SB′ supplied from the delay circuit 7 and each of the ideal sampling values which can be obtained as read sampling values and supplies the error as an error value (e) to each of crosstalk detecting circuits 202 and 203. For example, the error detecting circuit 201 extracts a sample existing at a position nearest to a zero-cross time point in the delayed read sampling value sequence SB′, that is, the central sample when its value is changed from positive to negative or from negative to positive in the three continuous read sampling value sequence and an error between the central sample and the actual “0” value is set to the error value (e). The crosstalk detecting circuit 202 obtains a correlation between the read sampling value sequence SA and the error value (e), thereby detecting a crosstalk amount based on the read sampling value sequence SA which has been multiplexed to the delayed read sampling value sequence SB′. The crosstalk detecting circuit 202 supplies a crosstalk detection signal CR₁ corresponding to the crosstalk amount to a subtractor 211. The crosstalk detecting circuit 203 obtains a correlation between the delayed read sampling value sequence SC′ and the error value (e), thereby detecting a crosstalk amount based on the delayed read sampling value sequence SC′ which has been multiplexed to the delayed read sampling value sequence SB′. The crosstalk detecting circuit 203 supplies a crosstalk detection signal CR₂ corresponding to the crosstalk amount to the subtractor 211.

The subtractor 211 derives a differential value between the crosstalk detection signals CR₁ and CR₂ and supplies the differential value as a tracking offset signal T_{OFS} to the subtractor 17 shown in FIG. 1. That is, a magnitude balance between both of the crosstalk detection signals CR₁ and CR₂ is obtained by the difference between them and the tracking offset signal T_{OFS} indicating an amount of the tracking offset occurring in the direction on either the inner rim side or the outer rim side of the disk is obtained based on the magnitude balance.

The subtractor 17 obtains a tracking offset corrected tracking error signal TE by subtracting the tracking offset signal T_{OFS} from the tracking error signal Tₑ and supplies the tracking error signal TE to the pickup 10. A tracking actuator in the pickup 10 deviates the irradiating direction of each of the information reading beams in the disk radial direction by an amount corresponding to the tracking error signal TE.

As mentioned above, in the invention, the amount of tracking offset occurring in the direction on either the inner rim side or the outer rim side of the disk is detected based on the balance between the crosstalk amounts (CR₁ and CR₂) from the recording tracks (T+1) and (T−1) which are neighboring on both sides of the recording track (T) as a target to be read and the tracking offset amount is subtracted from the tracking error signal, thereby performing the offset correction.

According to the invention, therefore, even if the track pitch of the recording tracks formed on the recording disk is small, a preferable tracking control in which the offset component multiplexed to the tracking error signal has been removed can be performed.

Although the tracking offset detecting circuit 20 has the construction of simultaneously reading the three neighboring recording tracks by using the three beams, the invention is not limited to this construction. In short, as long as the signals recorded on the three neighboring recording tracks can be detected, any construction can be used.

What is claimed is:

1. A tracking control method in a recorded information reproducing apparatus having tracking error detecting means for detecting a tracking error based on a read signal obtained by photoelectrically converting reflection light when an information reading beam is irradiated onto a recording disk and a tracking actuator for allowing said information reading beam to trace a recording track on the recording disk based on said tracking error, wherein
a tracking offset is corrected by subtracting a value according to a balance between crosstalk amounts from recording tracks which are neighboring on both sides of the recording track as a reading target from said tracking error.

2. A method according to claim 1, wherein the value according to said balance is a differential value between the crosstalk amounts from the recording tracks which are neighboring on both sides of the recording track as said reading target.

3. A tracking control apparatus in a recorded information reproducing apparatus having tracking error detecting means for detecting a tracking error based on a read signal obtained by photoelectrically converting reflection light when an information reading beam is irradiated onto a recording disk and a tracking actuator for allowing said information reading beam to trace a recording track on the recording disk based on said tracking error, comprising:
crosstalk detecting means for detecting crosstalk amounts from recording tracks which are neighboring on both sides of said recording track as a first crosstalk and a second crosstalk based on said read signal;
a first subtractor for obtaining a value according to a balance between said first crosstalk and said second crosstalk as a tracking offset component; and
a second subtractor for subtracting said tracking offset component from said tracking error.

4. An apparatus according to claim 3, wherein the value according to said balance is a differential value between said first crosstalk and said second crosstalk.

5. An apparatus according to claim 3, further comprising an A/D converter for sampling said read signal and obtaining a read sampling value sequence,
and wherein said crosstalk detecting means comprises:
an error detecting circuit for detecting a value, as an error value, of a read sample existing at a position that is nearest to a zero-cross time point in said read sampling value sequence;
a first crosstalk detecting circuit for obtaining a crosstalk component from a recording track adjacent to one side of the recording track as a reading target based on a correlation between the read sampling value sequence read out from the recording track adjacent to said one side and said error value and for setting said crosstalk component to said first crosstalk; and
a second crosstalk detecting circuit for obtaining a crosstalk component from a recording track adjacent to the other side of the recording track as said reading target based on a correlation between the read sampling value sequence read out from the recording track adjacent to said other side and said error value and for setting said crosstalk component to said second crosstalk.
